(19) United States
(12) Patent Application Publication
(10) Pub. No.: US 2012/0070852 A1
(43) Pub. Date: Mar. 22, 2012

(54) ASSAY

(75) Inventors: Molly Stevens, London (GB); James Eric Ghadiali, London (GB)

(73) Assignee: IMPERIAL INNOVATIONS LIMITED, London (GB)

(21) Appl. No.: 13/132,483

(22) PCT Filed: Dec. 1, 2009
(86) PCT No.: PCT/EP2009/066121

§ 371 Date: Dec. 9, 2011

(30) Foreign Application Priority Data
Dec. 1, 2008 (EP) 0822010.5

(51) Int. Cl. G01N 21/64; B82Y 15/00

(52) U.S. Cl. 435/7.72; 977/773; 977/902; 977/774

(57) ABSTRACT

The present invention relates to an assay for transferases. The assay comprises a first moiety comprising a transferase substrate and a second moiety capable of binding to the transferase substrate after it has been acted on by the transferase. One of the first and second moieties comprises a fluorophore and the other of the first and second moieties causes a change in fluorescence of the fluorophore. Thus, when the second moiety binds the transferase substrate after it has been acted on by the transferase, a change in fluorescence can be detected. The assay allows for agents that modulate the activity of the transferase to be screened.

The present invention relates to an assay. In particular, it relates to an assay for transferase enzymes, such as protein kinases and acetyl transferases.

Assays for enzymes are useful for detecting the activity of the enzyme, e.g. in diagnosis, as well as for screening for agents which can modulate the activity of the enzyme. Such agents may be used to treat diseases associated with the enzyme in question.

One particular group of enzyme is known as the transferases, and protein kinases are one family of enzymes within that group. Protein kinases constitute a large family of enzymes which catalyse the transfer of phosphate to the hydroxyl side chain of serine, threonine and tyrosine residues. As they are intimately tied to the regulation of many fundamental cellular processes, kinase dysfunction is often manifested in the development of numerous disease states, notably cancer (Science 298, 1912 (1998)). As such, there is a strong incentive to develop assays to detect and measure kinase activity and potential small molecule regulators of their activity (Nature Biotechnology 20, 270-274 (2002)).

Another family in the group of transferases is the histone acetyltransferases (HATs). These enzymes catalyse the transfer of acetyl groups from the co-substrate acetyl coenzyme A (acetyl-CoA) to the amino groups of lysine amino acid residues. This class of covalent modification occurs ubiquitously within the nucleus and plays a fundamental role in the regulation of gene expression, modulation of DNA metabolism and preservation of genome integrity. Furthermore, dysfunction in histone acetylation is often associated with the development of numerous disease states such as cancer and neurodegenerative conditions. As such, the ability to measure HAT activity is of great utility with view to developing small-molecule effectors of the enzyme's activity which may have utility in treating disease.

In a first aspect, the present invention provides an assay, comprising:
a first moiety comprising a transferase substrate; and
a second moiety capable of binding to the transferase substrate after it has been acted on by the transferase,
wherein one of the first and second moieties comprises a fluorophore and the other of the first and second moieties causes a change in fluorescence of the fluorophore, such that, when the second moiety binds the transferase substrate after it has been acted on by the transferase, a change in fluorescence can be detected.

Because a change in fluorescence, that is caused when the substrate is acted on by the transferase, is detected, the assay of the invention is rapid, does not require any separation steps or additional coupled enzyme reaction for signal development. Moreover, the assay can be readily tailored to assay transferases with different substrate specificity by simply changing the transferase substrate.

In a second aspect, the present invention provides a method for screening for an agent that modulates the activity of a transferase, comprising:
contacting the transferase, in the presence of an agent to be screened, with a first moiety comprising a transferase substrate; and a second moiety capable of binding to the transferase substrate after it has been acted on by the transferase,
wherein one of the first and second moieties comprises a fluorophore and the other of the first and second moieties causes a change in fluorescence of the fluorophore, such that, when the second moiety binds the transferase substrate after it has been acted on by the transferase, a change in fluorescence can be detected, and wherein the agent is a modulator of the activity of the transferase if the change in fluorescence is altered in the presence of the agent compared to the change in fluorescence when the agent is absent.

In one embodiment of the invention, the first moiety comprises the fluorophore and the transferase substrate is attached or otherwise immobilised thereon/thereto. In this embodiment, the second moiety causes a change in fluorescence of the fluorophore. In an alternative embodiment, the second moiety comprises the fluorophore. In this embodiment, the first moiety causes a change in fluorescence of the fluorophore when the second moiety binds to the transferase substrate after it has been acted on by the transferase. In either instance, the change in fluorescence may be a change in intensity or in lifetime.

The fluorophore may be a photoluminescent semiconductor nanocrystal, known as a quantum dot (Qdot or QD). Quantum dots are a nanomaterial and exhibit photoluminescent properties with distinct advantages over traditional organic fluorescent dyes in the context of biological imaging and sensing.

Bioconjugates of quantum dots have been developed for use in a wide range of biological imaging and analytical applications. Their chemical stability, resistance to photobleaching, broad excitation spectra and narrow size-tunable emission spectra render them attractive alternatives to organic dyes (Science 281, 2016 (1998)). Qdots also have the advantage of being able to serve as three-dimensional scaffolds, allowing multiple peptides or other moieties to assemble on the surface thereof. For example, multiple transferase substrates peptides per Qdot can be acted on by the transferase being assayed. As a result, multiple second moieties can bind to the Qdot. Thus the ratio of second moiety to Qdot is much greater than in the case of using a single substrate labelled with an individual fluorophore, allowing the Qdot format to have a much stronger signal. Thus, the three-dimensional and multivalent nature of the substrate-QDot conjugate improves the sensitivity of the assay. The precise physical composition of the photoluminescent Qdot can vary (e.g. CdSe, CdSe/ZnS, CdTe, CdS or any other semiconductor material that exhibits quantum confinement and optical properties typical of those of quantum dots).

As quantum dots are typically produced on a large scale by colloidal synthesis in organic solvent, it is necessary to render them to be water soluble and compatible in a range of biological buffers. Numerous schemes have been developed to achieve this phase transfer from organic to aqueous solution. Water soluble quantum dots can be biologically-functionalised by utilising a range conjugation strategies (electrostatic interactions, avidin-biotin chemistry, covalent coupling), following which they can be applied to a biological sensing system.

Nucleic acids, proteins, immunoglobulins and peptides can be immobilised on the surface of quantum dots, using a variety of bioconjugation strategies, to form devices for the detection of numerous biological analytes, biological interactions and enzyme activity (Nature Materials 4, 826-831 (2005); Nature Biotechnology 21, 41-46 (2002); Nature Biotechnology 22, 969-976 (2004)). Thus, the present invention can be used for the detection of transferase activity on any of these substrates. Many of the known detection methods are based on the non-radiative fluorescence energy transfer (FRET) between the excited-state donor quantum dot and a suitable proximal acceptor molecule; namely an organic dye, gold nanoparticle or another suitable quencher molecule (Nature Materials 4, 435-446 (2005); ChemPhysChem 7, 47-57 (2006)).

This Qdot sensing approach based on FRET has been applied to the detection of several classes of enzyme, including proteases, nucleases and DNA polymerases in both homogeneous and surface-based assay formats (Biochemical and Biophysical Research Communications 334, 1317-1321 (2005); J. Am. Chem. Soc., 128 10378-10379 (2006); Nature Materials 5, 581-589 (2006); J. Am. Chem. Soc. 130, 5720-5725 (2008)). However, these assays rely on the action of the enzyme causing a fluorophore-acceptor pair to become dissociated, resulting in a change in fluorescence.

Although several recent studies have demonstrated how the optical properties of certain inorganic nanoparticles, namely gold, can be utilised to create sensing systems for the detection of protein kinase activity, Qdots have not been used or suggested as potential reagents for kinase sensing (J. Am. Chem. Soc., 128, 2214-2215 (2006); Anal. Chem. 77, 5770-5774 (2005); Analytical Biochemistry 373, 161-163 (2008)).

The present invention is not limited to using Qdots as the fluorophore, and any other suitable fluorophore may be used. Examples of such fluorophores are set out in Ishida et al, J Pharmacol Sci, 103, 5-11 (2007).

The moiety which causes a change in fluorescence of the fluorophore is preferably a suitable proximal acceptor molecule; such as an organic dye, gold nanoparticle or another suitable quencher molecule (Nature Materials 4, 435-446 (2005); ChemPhysChem 7, 47-57 (2006)). As the assay of certain embodiments of the present invention is based on fluorescence energy transfer (FRET), for an efficient energy transfer process, it is preferred if a) the donor and acceptor fluorophores come within close proximity (typically<10 nm) and b) the emission spectra of the donor fluorophore overlaps with the excitation spectra of the acceptor. This results in non-radiative transfer of energy to the acceptor from the donor, resulting in increased acceptor-specific fluorescence and diminished acceptor-specific fluorescence. In addition to causing changes in fluorescence intensity, this energy transfer process also changes the fluorescence lifetime of the donor and acceptor and provides an additional means to measure the energy transfer that can be utilised in the present invention.

Organic fluorescent dyes, gold nanoparticles (of a range of dimensions, from 1.4 nm to 40 nm and larger), and other dark-quenching groups (acceptors which are not intrinsically fluorescent themselves, but reduce the donor-specific fluorescence intensity), intrinsically fluorescent proteins (GFP etc) and dye-labelled proteins have been demonstrated to act as energy acceptors for quantum dots, and hence can be used in the present invention. Furthermore, quantum dots can be used, in accordance with the invention, as bioluminescence resonance energy transfer acceptors when they are in close proximity to a bioluminescent protein (Nature Biotechnology 24, 339-343 (2006)).

In one embodiment of the invention, the transferase is a kinase. However, the transferase could be any transferase, including but not restricted to methyl-, acetyl-, sumoyl-, ADP-ribosyl- or a glycosyl-transferases. These transferase enzymes play a range of important roles in the regulation of gene expression and protein function. In order for certain transferases to act on their substrate, one or more co-factors may be required, and such co-factors may be included in the present invention where appropriate.

In another embodiment, the transferase is a histone acetyltransferase (HAT). As mentioned, the ability to measure HAT activity is of great utility with view to developing small-molecule effectors of the enzyme's activity which may have utility in treating disease. In this regard, the genome of eukaryotic cells is condensed into the nucleus by means of the formation of protein-DNA interactions mediated by histone proteins to form higher-order structure known as chromatin. Histones are highly basic proteins consisting of two copies of the core proteins H2A, H2B, H3 and H4 arranged to form an octameric complex. The individual histone proteins consist of a globular C-terminal core domain and a flexible lysine-rich N-terminus ('tail') which protrudes from the core, as revealed in the X-ray crystal structure (Luger et al, Science, 389, 251-260 (1997)). 146 base pairs of DNA are spooled around the nucleosome structure in a left handed superhelix to provide the fundamental repeating unit of chromatin structure—the nucleosome core particle—and additional accessory proteins further facilitate condensation of the DNA. This process, which results in a 10⁴-fold compaction, must be reconciled with the fact that a multitude of DNA-binding proteins require unhindered access to their target sequences in order to maintain tight temporal regulation of fundamental processes associated with DNA metabolism, such as replication, repair, recombination, transcription and integration of extracellular signals with changes in nuclear activity. It is now well understood that underlying chromatin structure plays a fundamental role in the regulation of these processes which, in turn, is determined by precisely controlled post-translational modification of histone side chains. The lysine-rich N-terminal histone tails are subject to a wide range of reversible modifications including acetylation, methylation, phosphorylation, ubiquitinylation, ADP-ribosylation and SUMOylation. These modifications serve as recruitment sites for a plethora of transcription factors and other effectors of chromatin structure by means of complementary protein domains which are capable of recognising specific side-chain modifications (Berger et al, Nature, 447, 407-412 (2007)). The notion that an underlying language exists which relates combinations of histone modifications to specific changes in chromatin structure and gene expression is known as the histone code hypothesis (Jenuwein et al, Science, 293, 1074-80 (2001)).

There is increasing evidence that histone modification and global epigenetic variations may play a significant role in the development of several disease states by means of several potential mechanisms (Seligson et al, Nature, 435, 1262-1266 (2005)). For example, trimethylation of lysine 9 of histone 3 (H3K9me3) is typically associated with the establishment and maintenance of transcriptionally silent heterochromatin and is essential to preserve genomic integrity. The protein, GASC1, has been found to be overexpressed in oesophageal squamous cell carcinoma and possesses H3K9me3/H3k9me2 demethylation activity, as observed in vitro and in vivo, and aberrant overactivity may contribute to de-repression of previously silent oncogenes (Cloos et al, Nature, 442, 307-311 (2006)). In addition, mouse models of Huntington's disease suggest that aberrant epigenetic control of transcription plays a role in disease aetiology, as treatment with histone deacetylase (HDAC) inhibitors results in increased histone acetylation in the brain and correlates with amelioration of disease symptoms (Hockly et al, Proc. Natl. Acad. Sci. PNAS, 100, 2041-2046 (2003)). Finally, global analysis of histone acetylation patterns in prostate cancer cells can serve as an accurate indicator of disease prognosis (Seligson et al, Nature, 435, 1262-1266 (2005)).

The transferase substrate is any suitable substrate for a transferase that is the subject of the assay. In some embodiments, the substrate may be a full-length recombinant protein, recombinant peptide or a synthetic peptide consisting of a minimal amino acid sequence that is necessary and sufficient to be acted upon by a corresponding transferase. These sequences could be derived from the analysis of fragments of proteins which are known substrates for transferases or from combinatorial screening of peptide libraries to identify synthetic substrate sequences. In one embodiment, the substrate is a polypeptide, which may be at least four amino acids in length. Suitable substrates are known to those of skill in the art and include a polypeptide having the sequence IYGEFKKK, which is a substrate for the kinase v-Src. Alternative substrates include a polypeptide having the sequence EAIYPFAEE, which is a substrate for the kinase Abl or having the sequence RGKGGKGLGKGA, which is a substrate for the histone acetyltransferase p300.

The second moiety is capable of binding to the transferase substrate after it has been acted on by the transferase, i.e. it can distinguish between the transferase substrate before and after the action of the transferase that is the subject of the assay. In this sense, the second moiety can be considered to be specific for the transferase substrate after it has been acted on by the transferase. The second moiety may recognise/bind to the group or groups that the transferase causes to be attached to the transferase substrate.

The second moiety may comprise an antibody. An “antibody” is an immunoglobulin, whether natural or partly or wholly synthetically produced, monoclonal or polyclonal. The term also covers any polypeptide, protein or peptide having a binding domain which is, or is homologous to, an antibody binding domain. These can be derived from natural sources, or they may be partly or wholly synthetically produced. Examples of antibodies are the immunoglobulin isotypes and their isotypic subclasses; fragments which comprise an antigen binding domain such as Fab, scFv, Fv, dAb, Fd; and diabodies.

It is possible to take monoclonal and other antibodies and use techniques of recombinant DNA technology to produce other antibodies or chimeric molecules which retain the specificity of the original antibody. Such techniques may involve introducing DNA encoding the immunoglobulin variable region, or the complementary determining regions (CDRs), of an antibody to the constant regions, or constant regions plus framework regions, of a different immunoglobulin. See, for instance, EP-A-184187, GB 2188638A or EP-A-239400. A hybridoma or other cell producing an antibody may be subject to genetic mutation or other changes, which may or may not alter the binding specificity of antibodies produced.

As antibodies can be modified in a number of ways, the term “antibody” should be construed as covering any binding member or substance having a binding domain with the required specificity. Thus, this term covers antibody fragments, derivatives, functional equivalents and homologues of antibodies, including any polypeptide comprising an immunoglobulin binding domain, whether natural or wholly or partially synthetic. Chimeric molecules comprising an immunoglobulin binding domain, or equivalent, fused to another polypeptide are therefore included. Cloning and expression of chimeric antibodies are described in EP-A-0120694 and EP-A-0125023.

It has been shown that fragments of a whole antibody can perform the function of binding antigens. Examples of binding fragments are (i) the Fab fragment consisting of VL, VH, CL and CH1 domains; (ii) the Fd fragment consisting of the VH and CH1 domains; (iii) the Fv fragment consisting of the VL and VH domains of a single antibody; (iv) the dAb fragment (Ward, E. S. et al., Nature 341:544-546 (1989)) which consists of a VH domain; (v) isolated CDR regions; (vi) F(ab′)2 fragments, a bivalent fragment comprising two linked Fab fragments (vii) single chain Fv molecules (scFv), wherein a VH domain and a VL domain are linked by a peptide linker which allows the two domains to associate to form an antigen binding site (Bird et al., Science 242:423-426 (1988); Huston et al., PNAS USA 85:5879-5883 (1988)); (viii) bispecific single chain Fv dimers (PCT/US92/09965) and (ix) “diabodies”, multivalent or multispecific fragments constructed by gene fusion (WO94/13804; P. Hollinger et al., Proc. Natl. Acad. Sci. USA 90:6444-6448 (1993)).

The term “antibody” also includes antibodies which have been “humanised”. Methods for making humanised antibodies are known in the art. Methods are described, for example, in Winter, U.S. Pat. No. 5,225,539. The term “antibody” also includes antibodies which have been “chimerised”. Methods for making chimerised antibodies are known in the art. Such methods include, for example, those described in U.S. patents by Boss (Celltech) and by Cabilly (Genentech). See U.S. Pat. Nos. 4,816,397 and 4,816,567, respectively.

Alternatively, the second moiety may comprise a protein domain which specifically recognises the substrate in its modified state (e.g. an SH2 domain which recognises phospho tyrosine residues in certain peptide sequences), a nucleic acid or peptide aptamer generated by in vitro selection which selectively binds to the modified substrate or another small molecule affinity ligand, including metal ion-containing chelates, which bind selectively to the modified substrate.

In those embodiments of the invention that relate to kinases, the second moiety may comprise a phosphate recognition motif. In one embodiment, the second moiety is a monoclonal phospho-specific antibody, i.e. a monoclonal antibody that binds specifically to a phosphate group. Such antibodies are commercially-available. Alternatively, or additionally, the second moiety may be another fluorophore-labelled phosphate recognition motif, such as a phosphate-specific nucleic acid aptamer or divalent metal ion chelation complex. Alternatively, where the present invention is intended to be for use in assaying an acetyl transferase, the second moiety may comprise an acetyl recognition motif. Thus, the second moiety may be an antibody that binds specifically to an acetyl group, such as an acetyl lysine group.

In one embodiment, the first moiety comprises a fluorophore and the kinase substrate is attached or otherwise immobilised thereon/thereto. When the fluorophore is a quantum dot and the kinase substrate is a polypeptide, the polypeptide may be attached to the quantum dot by means of a poly-Histidine (e.g. His₆) tag. In this embodiment, the second moiety causes a change in fluorescence of the fluorophore. Thus, the second moiety may include an organic dye, gold nanoparticle or another suitable quencher molecule.

In one embodiment, water-soluble quantum dots are functionalised with peptide substrates for a clinically-relevant protein kinase. Upon exposure of the quantum dot-peptide conjugate to enzyme in the presence of ATP, the conjugate becomes phosphorylated. This enzyme-dependent phosphorylation event can be subsequently detected by means of a phospho-specific antibody conjugated to a fluorescent dye. The resultant close proximity of the dye-labelled antibody to the quantum dot permits an energy transfer process to take place (FRET) and the interaction can be readily detected spectroscopically. Thus, in this embodiment, quantum dot-peptide conjugates can serve as effective substrates for protein kinases and, following exposure to enzyme and ATP, the phosphorylation event can be directly detected using a FRET-based approach.

In another embodiment, the invention can be used to assay an acetyl transferase. In this instance, the assay may be the same as described above, except that the substrate may be exposed to the enzyme in the presence of acetyl-CoA.

In certain embodiments, the present invention can be used to assay for a plurality of enzymes in a single reaction. This can be achieved by using a specific fluorophore with each transferase substrate. Thus, the activity of a transferase is indicated by the change in a fluorescence of the fluorophore associated with the transferase substrate.

Preferred features of each aspect of the invention are as for each of the other aspects mutatis mutandis. The prior art documents mentioned herein are incorporated by reference to the fullest extent permitted by law.

### EXAMPLES

The present invention will now be described with reference to the following non-limiting examples. Reference is made to the accompanying drawings in which:

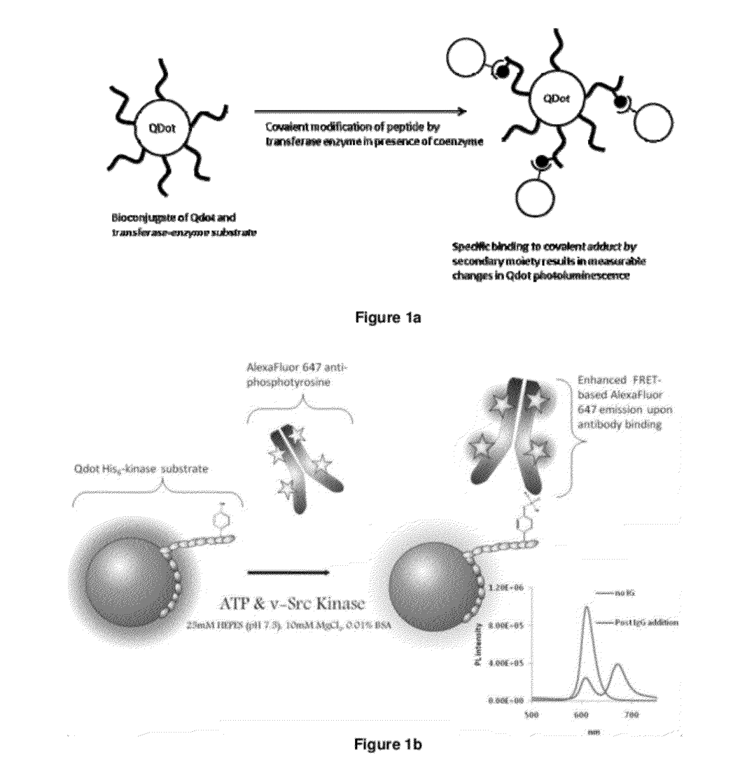

FIG. 1a is a schematic illustration of one embodiment of the present invention. The surface of a quantum dot is modified with a substrate for a transferase enzyme. Exposure of the quantum dot-substrate conjugate to a cognate transferase in the presence of a coenzyme results in the covalent modification of the quantum dot substrate conjugate. Introduction of a secondary moiety which binds selectively to the covalent adduct results in changes in the photoluminescent properties of the quantum dot. FIG. 1b illustrates a specific embodiment using a peptide substrate for a kinase and a labelled antibody to detect the peptide after it has been phosphorylated by the kinase.

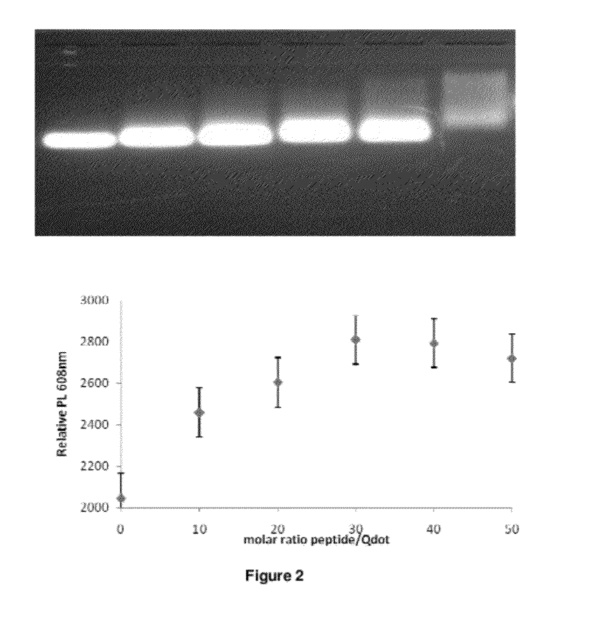

FIG. 2: Peptide titration with MPA-capped Qdots; altered electrophoretic mobility (upper) and photoluminescence enhancement (lower) (peptide:Qdot ratio 0; 10; 20; 30; 40; 50:1).

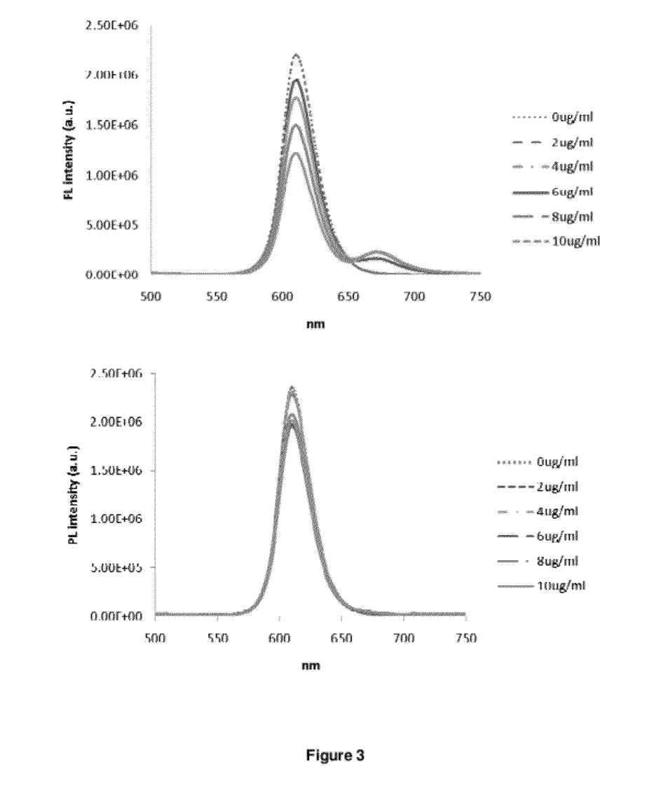

FIG. 3: IgG Alexa Fluor 647 titration to reaction mixtures containing Qdot-peptide conjugate and Src kinase in the presence (upper) or absence (lower) of ATP.

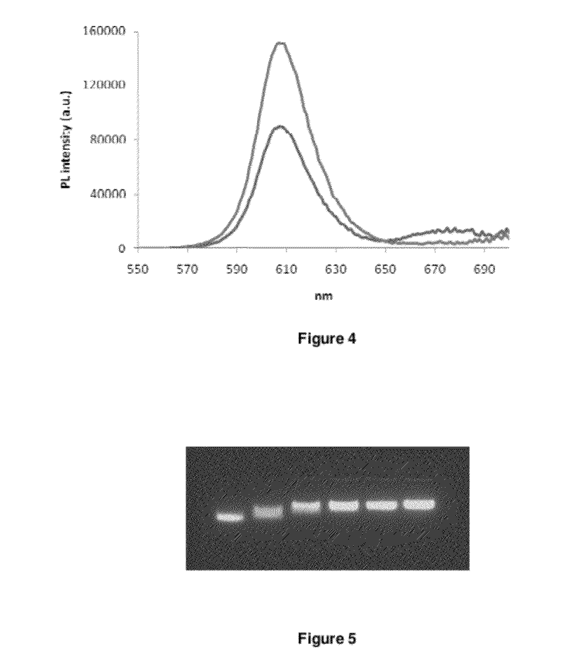

FIG. 4: Presence of phosphotyrosine BSA inhibitor (upper line) inhibits energy transfer, as evident from increased Qdot-specific emission and diminished Alexa Fluor 647 emission, relative to reactions in the absence of inhibitor (lower line).

FIG. 5: Representative gel mobility data. Src substrate (Ac-IYGEFKKKH₆-CONH₂) incubated with 100 nM QDs. Lanes left to right; 0, 10, 20, 30, 40, 50:1 peptide excess to QD.

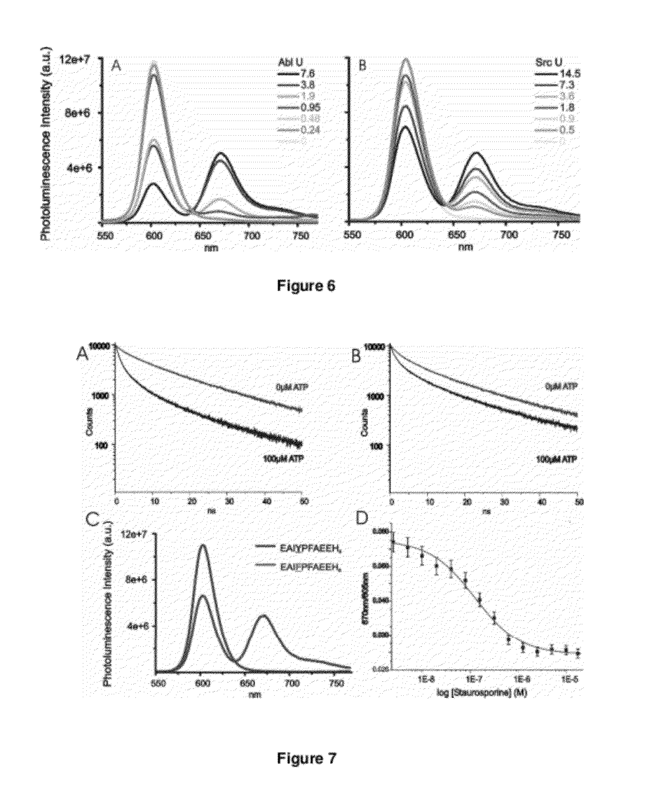

FIG. 6: Steady state emission spectra (λₑₓ=400 nm) of Abl (A) and Src (B) kinase reactions using peptide-QD conjugate substrates following 1 hr enzyme reactions and addition of FRET-acceptor labelled antibody.

FIG. 7: Transient PL emission detected by time-correlated single-photon counting, following 440-nm excitation of Abl- (A) and Src- (B) substrate-conjugated QDs, following kinase phosphorylation and acceptor-labelled antibody addition in the presence or absence of ATP; (C) Effect of Y/F substitution on steady state photoluminescence (Abl); (D) Staurosporine inhibition of Abl dose response curve.

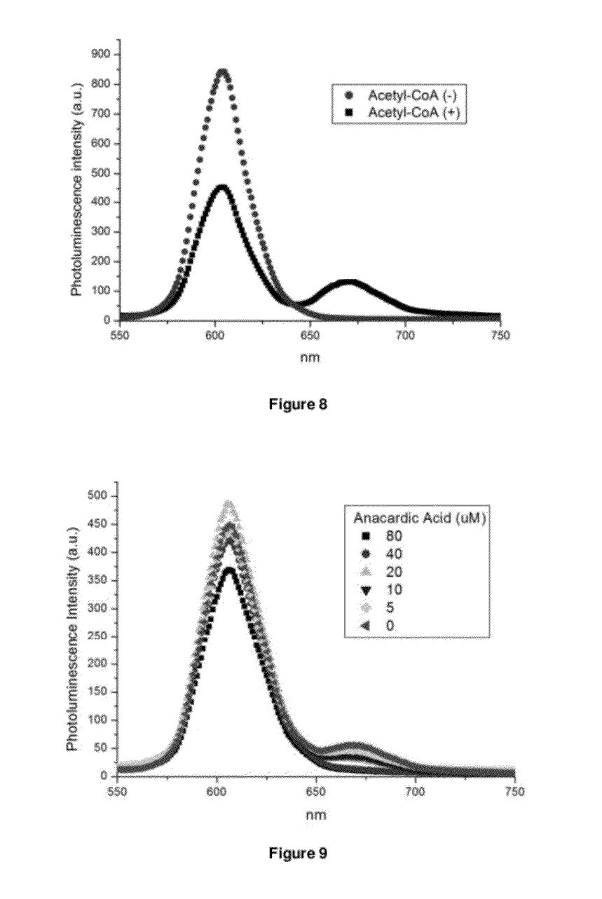

FIG. 8: p300 HAT assay. Steady-state photoluminescence of QDs treated with p300, p300 peptide substrate and dye-labelled anti-acetyl lysine antibody in the presence (+) or absence (−) of 100 μM acetyl-CoA. Acetyl-CoA-dependent energy transfer is indicated by a concomitant increase in dye-specific emission at 670 nm and decrease in QD-specific emission at 605 nm.

FIG. 9: (p300 HAT assay inhibitor response) Response of p300 assay to the presence of different concentrations of the inhibitor anacardic acid. Increasing concentrations of anacardic acid result in diminished energy transfer, consistent with specific small-molecule inhibition of p300 HAT activity.

### EXAMPLE 1

The activity of a constitutively active form of Src kinase, v-Src; a well characterised tyrosine kinase (Biochemical and Biophysical Research Communications 324, 1155-1164 (2004)) was examined. A synthetic peptide substrate for v-Src was immobilised on the surface of water-soluble mercaptopropionic acid-capped CdSe/ZnS quantum dots using a previously-reported metal affinity self-assembly process; driven by virtue of a hexahistidine motif incorporated into the peptide sequence (Nature Protocols 1, -1258-1266 (2006)). This method was chosen for bioconjugation owing to the stability of the multidentate His₆-ZnS interaction which simultaneously allows the final hydrodynamic radius of the resultant bioconjugate to remain reasonably small, thus favouring an efficient energy transfer process. In the presence of enzyme and a suitable phosphate donor (ATP), tyrosine residues on the surface of the Qdot-peptide become phosphorylated. This phosphorylation event is detected on addition of an acceptor-dye labelled anti-phosphotyrosine antibody. The formation of this recognition complex is detected spectroscopically by the sensitised emission of the dye-labelled antibody and quenched emission from the Qdot as a result of the decreased distance between the Qdot-antibody fluorophores.

### Materials and Methods

Water solubilisation procedure: Stable water soluble quantum dots were prepared using a procedure similar to that described in a recent report (Langmuir, 24, 5270-5276 (2008)). Commercial organic quantum dots with an emission peak at 605 nm (Qdot605) (Invitrogen) were flocculated from decane with a four-fold volume equivalent of 75/25 MeOH/iPrOH (Fluka), centrifuged at 13,000 g for 3 minutes and resuspended in 1 ml of CHCl₃ to a final concentration of 0.1 μM (ε=650,000 M⁻¹cm⁻¹ at exciton absorption peak between 596 nm & 604 nm, manufacturer's information). To prepare the ligand exchange solution, 1 g of tetramethyl ammonium hydroxide pentahydrate (TMAOH) (Sigma) and 500 μl of mercaptopropionic acid (MPA) (Sigma) was dissolved in 10 ml CHCl₃ (Fluka). The resultant two-phase solution was mixed well, allowed to stand for 1 hr at room temperature and the lower organic phase containing deprotonated MPA was recovered for the ligand exchange reaction. 1 ml of the 0.1 μM Qdots in CHCl₃ was added and the solution was allowed to stand for 40 hrs at room temperature. Following this time the Qdots formed a luminescent droplet floating above the CHCl₃ phase. 10 ml of 10 mM sodium borate buffer (pH 9.6) was added and the Qdots were observed to completely transfer into the aqueous layer. The aqueous layer was washed three times with 10 ml of CHCl₃ and further purified using three rounds of twenty-fold concentration/dilution using a 10 KDa MWCO ultrafiltration device (Millipore) to remove excess MPA. The water soluble Qdot-MPA conjugates were stored in 10 mM sodium borate buffer (pH 9.6) at 4° C. at a concentration of 0.1 μM prior to use.

Peptide synthesis: The hexahistidine derivative of a substrate peptide for v-Src (Ac-IYGEFKKKHHHHHHCONH₂) was prepared using standard Fmoc peptide synthesis using an Aaptec Apex 396 combinatorial peptide synthesiser. Peptides were synthesised on a 0.1 mmol rink amide resin (Novabiochem) using four-fold excess of Fmoc side-chain protected amino acid monomers (Novabiochem) with a DIC/HOBt coupling agent in DMF. Following automated synthesis, the N-terminus of the peptide was acetylated by treating the resin with an acetic anhydride/DIEA/DMF (1/1/8) solution for 1 hr. The resin was washed extensively with DMF, dried with DCM and the peptides subsequently cleaved and deprotected using a standard TFA/TIS/H₂O (95/2.5/2.5) solution for 3 hrs. The crude product was precipitated and washed in cold diethyl ether and purified (>98%) by reverse phase HPLC. Identity and purity of the peptide was verified by liquid chromatography-mass spectrometry (LC-MS).

Peptide/Qdot conjugation: 3 μl of a 100 μM solution of peptide was added to 100 μl of Qdot-MPA in 10 mM borate buffer (pH 9.6), the solution vortexed gently and allowed to stand for 30 minutes. Self-assembly of the peptide on the Qdot was confirmed by altered electrophoretic mobility relative to the non-conjugated water soluble Qdots on an agarose gel (0.5% w/v agarose, 1×TBE, 100V). Photoluminescence spectra of the conjugates (400 nm excitation) revealed a 40% emission enhancement at 608 nm in the presence of peptide, consistent with assembly of the peptide on the Qdot surface.

Antibody-Alexa fluor 647 labelling reaction: Alexa Fluor 647 (Invitrogen) was chosen to serve as the acceptor fluorophore owing to good spectral overlap with Qdot₆₀₅ (Analytical Biochemistry 357, 68-76 (2006)). 100 μl of 1 mg/ml mouse monoclonal anti-phosphotyrosine IgG, (clone PT-66) in PBS was incubated with an amine-reactive succinimidyl ester derivative of Alexa Fluor 647 (Invitrogen) for 1 hr at room temperature with a dye:protein ratio 8:1. The dye was pre-aliquoted in dry DMF and stored at −80° C. prior to use and the total concentration of DMF in the reaction mixture was restricted to <2%. The fluorescent conjugate was purified by repeated rounds of centrifugal filtration on a 10 kDa MWCO filtration unit until the flow-though no longer exhibited dye-specific absorption. The ratio of dye:IgG was calculated using the molar extinction coefficient of the dye (ε₆₅₀=239,000M⁻¹cm⁻¹, manufacturer's data) and IgG (ε₂₈₀=203,000M⁻¹cm⁻¹). The final conjugate (dye: IgG, 4:1) was stored in PBS at 4° C. prior to use.

v-Src assay: The Qdot-peptide conjugates were transferred into enzyme assay buffer (25 mM HEPES (pH 7.5), 10 mM MgCl₂, 0.01% (w/v) BSA) using a 10 KDa MWCO ultrafiltration device. Passage of the solution through a 0.45 μm cellulose acetate filtration device did not reveal the presence of any large aggregates. In addition, centrifugation of the solution at 14,000 g for 10 minutes did not reveal any noticeable pellet formation, suggesting that the particles remained well dispersed. v-Src (Signalchem) was exchanged into assay buffer prior to use. 5 μl of 0.1 μM Qdot-peptide was incubated with 5 μl 400 μM ATP and 20 μl 80 ng/ml v-Src for 1 hr at 30° C. After which, 1 μl of IgG-Alexa Fluor 647 was added to reach a final concentration of 5 μg/ml. Control experiments were carried out in which ATP was replaced with reaction buffer. In this case, in the absence of a suitable phosphate donor, enzymatic phosphorylation is not possible, thus preventing immunorecognition of the phosphorylated quantum dot.

Fluorescence spectroscopy: Spectra were recorded on a Jobin Yvon FluoroMax-3 using a quartz micro-fluorescence cuvette. The excitation wavelength was set at 400 nm (an Alexa Fluor 647 absorption minimum) with 5 nm excitation/emission slit widths.

### Results

Gel electrophoresis and fluorescence spectroscopy verified that the His₆-peptide was capable of assembling on the surface of the MPA-capped Qdots (see FIG. 2). In the presence of 0.01% (w/v) BSA, the peptide conjugates were stable for weeks at 4° C. in a range of assay buffers (PBS, HEPES/MgCl₂) with no obvious sign of precipitation or loss in photoluminescence.

Addition of phosphotyrosine antibody to ATP-containing reaction mixtures resulted in a large increase in Alexa Fluor 647-based emission. Significant FRET signals could be observed rapidly (<1 min) following addition of the antibody to ATP-containing enzyme reaction mixtures, with the signal reaching saturation after ˜30 minutes (see FIG. 2a). Control experiments which omitted ATP from the reaction mixture did not give rise to such pronounced increases in Alexa Fluor 647 emission indicating that ATP-dependent enzyme phosphorylation drives formation of the immuno-complex (see FIG. 2b). Inclusion of a phosphotyrosine-conjugated BSA antibody inhibitor (Sigma) in the reaction mixture inhibited the Alexa Fluor 647 emission, further suggesting that immunocomplex formation with the Qdot-peptide was necessary for FRET to take place (see FIG. 4). Finally, titration of increasing concentrations of antibody to reaction mixtures containing ATP revealed a sequential decline in Qdot-specific photoluminescence at 605 nm, with an accompanying increase in AlexaFluor 647 emission at 670 nm, whereas control experiments in the absence of ATP did not exhibit such a trend.

In summary, the present example—which is non-limiting on the invention as a whole—illustrates a simple homogeneous assay for protein kinase activity based on FRET between a quantum dot-phosphopeptide donor- and a fluorophore labelled anti-phosphotyrosine antibody acceptor. The assay is rapid and does not require any separation steps or additional coupled enzyme reaction for signal development. The assay can be readily tailored to assay kinases with different substrate specificity by simply changing the sequence of the His₆-peptide substrate. Furthermore, the multiplexing capability of Qdots could allow several different kinases and other enzymes to be monitored simultaneously in a single reaction by judicious choice of Qdot/fluorophore pairs and cognate enzyme substrates. Whilst the assay described in this example assay relies on the use of monoclonal phospho-specific antibodies, other fluorophore-labelled phosphate recognition motifs could be employed to detect peptide phosphorylation (e.g. phosphate-specific nucleic acid aptamers or metal ion chelation complexes).

### EXAMPLE 2

### Materials and Methods

Quantum Dot Solubilization Procedure: Quantum dots (605-nm emission maximum) in decane were purchased from Invitrogen and rendered water soluble by base assisted ligand exchange (Pong, et al, Langmuir 2008, 24, 5270-5276).

The ligand exchange solution consisted of 1 g of tetramethylammonium pentahydrate and 500 μl of mercaptopropionic acid dissolved in CHCl₃ in a polypropylene centrifuge tube. The two-phase solution was mixed vigorously and allowed to stand for 1 hr. The organic phase was recovered and to this solution, 1 mL of QDs (100 nM) in CHCl₃ was added. The mixture was allowed to stand in the dark at room temperature for 40 hrs. Following this time, the QDs, as a photoluminescent droplet on the surface of the CHCl₃ phase, were washed 3× with 10 mL of CHCl₃. The QDs were then dissolved in 10 mL of 10 mM sodium borate buffer (pH 9.6) and subjected to three ten-fold concentration/dilution washing cycles using a 10 KDa molecular weight cut-off centrifugal filtration device (Millipore). The QDs were stored in the dark at 4° C. prior to use. The concentration of QDs was determined using an extinction coefficient of 650,000 M⁻¹ cm⁻¹ at the first exciton absorption peak. The quantum yield (QY) of 0.40 was determined relative to an absorption-matched solution of sulphorhodamine as a standard (QY=0.90) using previously reported methods (Han, et al., Journal of the American Chemical Society 2008, 130, 15811-15813). Peptide substrates and their respective Y/F substitution for v-Src and v-Abl (Ac-IYGEFKKKHHHHHH-CONH₂, Ac-IFGEFKKKHHHHHH-CONH₂, EAIYPFAEEHHHHHH-CONH₂, EAIFPFAEEHHHHHH-CONH₂) were synthesised by standard automated Fmoc solid-phase peptide synthesis from an Rink-amide solid support on an Aaptec ACT Apex 396 Peptide Synthesizer. The peptides were cleaved and deprotected with 95:2.5:2.5 trifluoroacetic acid: H₂O: triisopropylsilane for 3 hrs and precipitated and washed with cold diethyl ether. The crude peptides were purified to >98%, as determined by LC-MS, by semi-preparative C₁₈-HPLC using a water/acetonitrile mobile phase containing 0.1% (v/v) TFA.

Peptide conjugation: An aliquot of 3 μL of a 100 μM peptide solution in 10 mM sodium borate (pH 9.6) was added to 100 μl of 100 nM QDs, vortexed briefly and allowed to stand at room temperature for 1 hr. Following this, 10 μl of a 1% (w/v) solution of bovine serum albumin (≧99%) (Sigma) in PBS was added. The mixture was then diluted in 25 mM HEPES (pH 7.5), 10 mM MgCl₂, and subjected to 3×10-fold concentration/dilution cycles by centrifugal filtration. The inclusion of BSA to a final concentration of 0.1% (w/v) provided enhanced colloidal stability and was necessary to avoid non-specific binding.

Gel electrophoresis: 20 μl aliquots of MPA-capped QDs (100 nM) in 10 mM sodium borate (pH 9.6) were incubated for 1 hr with different volumes of peptide solution (1 μM) to achieve peptide:QD ratios ranging from 0-50:1. Glycerol (100%) was then added to the solutions to reach a final concentration of 5% (v/v) prior to gel electrophoresis. The peptide conjugates were run on 1% (w/v) agarose gels in 1×TAE buffer for 30 mins at 10 V/cm and imaged under 365 nm illumination. The QDs exhibited retarded electrophoretic mobility in the presence of peptide, however, the mobility did not change at ratios ≧30:1, suggesting saturation of free binding sites on the QD surface and providing a rough approximation of the final stoichiometry of the conjugate (see FIG. 5).

Antibody labelling: Monoclonal antiphosphotyrosine (clone PT-66) was obtained from Sigma. The antibody was buffer exchanged into azide-free phosphate buffered saline by centrifugal filtration and incubated with a 10-fold molar excess of Alexa Fluor 647 succinimidyl ester (Invitrogen) in dimethylformamide (final DMF concentration<1%) for 1 hr. The antibody was purified from excess-dye by spin dialysis until the retentate exhibited no further dye-specific absorption. The ratio of dye:protein was calculated according to the manufacturer's instructions and the conjugate was stored protected from light at 4° C. until use.

Enzyme reactions and PL: Purified recombinant Src and Abl were obtained from SignalChem and CalBiochem respectively. Enzyme reactions were carried out in polypropylene microtubes. The reaction mixtures consisted of 10 μl enzyme, 20 μl peptide-QD (30 nM final concentration) and 10 nM ATP (100 μM final concentration) in 25 mM HEPES (pH 7.5), 10 mM MgCl₂, and 0.1% (w/v) BSA (assay buffer). The reactions were carried out for 1 hr at 30° C. and quenched with 10 μl of EDTA (100 mM). 2 μl of the antibody-dye conjugate was then added to reach a final QD:antibody ratio of 4:1. The mixture was incubated for an additional 30 minutes at room temperature prior to recording photoluminescence spectra. Steady-state spectra were recorded on a Jobin Yvon FluoroMax-4 Flourimeter. The spectra were corrected for variations in lamp and detector intensity with files from Jobin Yvon.

Lifetime: Time-resolved PL spectra were collected on a Jobin Yvon Fluorolog TCSPC Spectrophotometer using a 200-ps 440-nm LED as excitation source. Average lifetimes were calculated by fitting the measured decays to a convolution of the instrument response function and a triple-exponential decay. The average lifetimes were calculated according to:

$$\overline{τ} = \frac{{α}_{1} {τ}_{1}^{2} + {α}_{2} {t}_{2}^{2} + {α}_{3} {τ}_{3}^{2}}{{α}_{1} {τ}_{1} + {α}_{2} {τ}_{2} + {α}_{3} {τ}_{3}}$$

The instrument response function was determined using an aqueous scattering solution of Ludox.

Inhibitor titration: Stock solutions of staurosporine (Calbiochem) were prepared in anhydrous DMSO and stored at −20° C. prior to use. Reactions were carried out in triplicate in 384-well black clear bottom plates (Nunc) with 2-fold dilutions of staurosporine in assay buffer. Reactions contained 5 μl of 5U v-Abl, 4 μl of peptide-QD conjugate (30 nM), 1 μl ATP and 10 μl staurosporine. As staurosporine is an ATP-competitive inhibitor, the concentration of ATP was held at the apparent Kₘ of 12.5 μM. Quenching and antibody detection was carried out as described, and the photoluminescence intensity at 605 nm and 670 nm was measured on a Spectra Max Gemini XS fluorescence microplate reader.

### Results

This example studies the activity of the prototypal non-receptor tyrosine kinases Abl and Src, which have a role in the progression of several forms of cancer (Cohen, Nat. Rev. Drug Discov. 2002, 1, 309-315; von Ahsen & Bomer, Chembiochem 2005, 6, 481-490). Water-soluble CdSe/ZnS QDs (605 nm emission maximum) were first prepared by base-promoted ligand exchange of the native hydrophobic surfactant coating with mercaptopropionic acid (MPA) (Cohen, Nat. Rev. Drug Discov. 2002, 1, 309-315; von Ahsen & Bomer, Chembiochem 2005, 6, 481-490). The MPA-capped QDs were then conjugated to peptide substrates for Abl and Src (H₂N-EAIYPFAEEH₆-CONH₂, Ac-IYGEFKKKH₆-CONH₂) by metal-affinity driven self-assembly via an appending hexahistidine motif (Boeneman, et al, J. Am. Chem. Soc. 2009, 131, 3828-3829). Formation of the conjugates was confirmed by agarose gel electrophoresis, with the peptide-QD conjugates exhibiting altered electrophoretic mobility relative to unmodified QDs and having an approximate peptide: QD stoichiometry of 30:1 (see above). The peptide-modified QDs showed good colloidal stability in assay buffer and no signs of macroscopic aggregation for several weeks when stored at 4° C.

The conjugates (30 nM QDs) were then incubated with different amounts of respective tyrosine kinase in the presence of excess ATP (100 μM) for one hour, after which the reaction was quenched by the addition of EDTA. The phosphorylated reaction products were then detected by addition of a phosphotyrosine-specific monoclonal antibody labeled with amine-reactive AlexaFluor 647 succinimidyl ester (c.a. 4 dyes/antibody). Owing to the appreciable overlap between the QD emission- and dye absorption, the QD and fluorophore can participate in energy transfer (Nikiforov & Beechem, Anal. Biochem. 2006, 357, 68-76). Upon antibody recognition of the phosphorylated peptide-QDs, the fluorophores attached to the antibody are brought into the proximity of the nanocrystal surface, within a distance regime commensurate with efficient FRET (Förster distance of 71.5 Å) (Nikiforov & Beechem, Anal. Biochem. 2006, 357, 68-76).

Steady state emission spectra revealed a concomitant decrease and increase in QD- and fluorophore-specific emission as a function of enzyme concentration, consistent with an enzyme-dependent FRET process for both Src and Abl (see FIG. 6).

These experiments demonstrated variations in the extent of energy transfer in the two enzyme systems, most likely reflecting subtle differences in specific substrate preference and different assay buffer requirements for maximal activity.

In order to confirm that QD-fluorophore energy transfer was responsible for the observed intensity changes, time correlated single photon counting (TCSPC) was also employed to examine changes in the QD exciton lifetime and revealed substantially diminished QD photoluminescence decay time in the presence of both enzyme and FRET acceptor-labeled antibody (see FIG. 7). Furthermore, control experiments in which ATP was omitted from the reaction mixture or with a peptide substrate containing a non-phosphorylatable Phe substituted for Tyr did not exhibit such behaviour (FIG. 7), providing strong support that the observed luminescence and lifetime changes were due to ATP-dependent tyrosine phosphorylation.

The ability to screen potential small-molecule inhibitors of tyrosine kinase activity is of significant importance in the drug discovery process (von Maltzahn, et al, Adv. Mat. 2007, 19, 3579-3581; Oishi, et al, Anal. Biochem. 2008, 373, 161-163; Wang, et al, J. Am. Chem. Soc. 2006, 128, 2214-2215; Kerman, et al, Bios. Bioelec. 2009, 24, 1484-1489; Shapiro, et al, J. Am. Chem. Soc. 2009, 131, 2484-2486; Laromaine, et al, J. Am. Chem. Soc. 2007, 129, 4156-4157; Guarise, et al, Proc. Natl. Acad. Sci. Am. 2006, 103, 3978-3982). As a proof of concept, the inventors further sought to investigate whether the system could be employed quantitatively to assess enzyme inhibitor potency. Abl kinase reactions were carried out in 384-well fluorescence microplates (25 μL, 0.2 UμL⁻¹ per well). The enzyme was preincubated with serial dilutions of the broad spectrum kinase inhibitor staurosporine prior to initiating the reaction with the addition of ATP. The relatively long wavelength emission of both QD and dye effectively prevented staurosporine autofluorescence from contributing to the measured signal. Following quenching and antibody addition, the emission intensities at 605 and 670 nm (QD and Alexa Fluor 647 emission maxima, respectively) were measured and converted into a ratio, 670 nm/605 nm, to generate a dose response curve which provided an IC₅₀ value of 100 nM, in good accordance with previously reported literature values (Rodems, et al, Assay Drug Dev. Tech. 2002, 1, 9-19). The ratiometric measurement used here enables quantitative data analysis and assists in accounting for potential well-to-well variations.

In summary, the present example demonstrates a rapid, homogeneous and generic assay for protein kinase activity based on QD-fluorophore energy transfer with detection sensitivity comparable to current state-of-the-art techniques (Imbert, et al, Assay Drug Dev. Tech. 2007, 5, 363-372). Whilst the dimensions of the IgG antibody used here are relatively large with respect to high efficiency FRET distances, the efficient FRET observed here can be attributed to a number of design features, namely i) the relatively large Förster distance; ii) the small hydrodynamic radius of the QD-peptide conjugate afforded by metal-affinity driven self-assembly; iii) each antibody is labeled with multiple acceptor fluorophores and iv) a single QD is capable of binding to multiple antibodies (approximately 4 per QD). In addition, given the amenability of QDs to multiplexed biosensing, through judicious choice of QD/fluorophore pairs, enzyme substrates and specific antibodies, it is possible to measure the activity of multiple kinases within a single reaction mixture. Finally, given the wide variety of post translational modifications and complementary antibodies available, the present invention allows the development of a new generation of enzyme assays based on QD FRET.

### EXAMPLE 3

The present example demonstrates the applicability of the present invention to the measurement of other transferases.

### Materials and Methods

Water solubilisation procedure: Stable water soluble quantum dots were prepared using a procedure similar to that described in a recent report (Langmuir, 24, 5270-5276 (2008)). Commercial organic quantum dots with an emission peak at 605 nm (Qdot605) (Invitrogen) were flocculated from decane with a four-fold volume equivalent of 75/25 MeOH/iPrOH (Fluka), centrifuged at 13,000 g for 3 minutes and resuspended in 1 ml of CHCl₃ to a final concentration of 0.1 μM (ε=650,000M⁻¹ cm⁻¹ at exciton absorption peak between 596 nm & 604 nm, manufacturer's information).

To prepare the ligand exchange solution, 1 g of tetramethyl ammonium hydroxide pentahydrate (TMAOH) (Sigma) and 500 μl of mercaptopropionic acid (MPA) (Sigma) was dissolved in 10 ml CHCl₃ (Fluka). The resultant two-phase solution was mixed well, allowed to stand for 1 hr at room temperature and the lower organic phase containing deprotonated MPA was recovered for the ligand exchange reaction. 1 ml of the 0.1 μM Qdots in CHCl₃ was added and the solution was allowed to stand for 40 hrs at room temperature. Following this time the Qdots formed a luminescent droplet floating above the CHCl₃ phase. 10 ml of 10 mM sodium borate buffer (pH 9.6) was added and the Qdots were observed to completely transfer into the aqueous layer. The aqueous layer was washed three times with 10 ml of CHCl₃ and further purified using three rounds of twenty-fold concentration/dilution using a 10 KDa MWCO ultrafiltration device (Millipore) to remove excess MPA. The Qdots were resuspended in 50 mM Tric-HCl buffer (pH 8.0) containing 0.1% (w/v) bovine serum albumin and stored at 4° C. before use.

Peptide synthesis: A synthetic peptide substrate for p300, based on residues 3-14 of the N-terminal domain of Histone 4 (Thompson, P. et al. J. Biol. Chem. 276, 33721 (2001)), with an appending C-terminal hexahistidine motif (H₂N-RGKGGKGLGKGAHHHHHH-CONH₂) was prepared by automated solid-phase peptide synthesis on an Applied Biosystems ABI 433A synthesiser. Peptides were synthesised on a 0.1 mmol rink amide resin (Novabiochem) using ten-fold excess of Fmoc side-chain protected amino acid monomers (Novabiochem) with a HBTU/HOBt coupling agent in DMF. Following automated synthesis, the N-terminus of the peptide was acetylated by treating the resin with an acetic anhydride/DIEA/DMF (1/1/8) solution for 1 hr. The resin was washed extensively with DMF, dried with DCM and the peptides subsequently cleaved and deprotected using a standard TFA/TIS/H₂O (95/2.5/2.5) solution for 3 hrs. The crude product was precipitated and washed in cold diethyl ether and purified (>98%) by reverse phase HPLC. Identity and purity of the peptide was verified by matrix-assisted laser desporption/ionization mass spectrometry.

Antibody-Alexa Fluor 647 labelling reaction: Alexa Fluor 647 (Invitrogen) was chosen to serve as the acceptor fluorophore owing to good spectral overlap with Qdot₆₀₅ (Analytical Biochemistry 357, 68-76 (2006)). 100 μl of 0.5 mg/ml mouse monoclonal anti-acetyl lysine (anti-AcK, Abcam) in PBS was incubated with an amine-reactive succinimidyl ester derivative of Alexa Fluor 647 (Invitrogen) for 1 hr at room temperature with a dye:protein ratio 20:1. The dye was pre-aliquoted in dry DMSO and stored at −80° C. prior to use and the total concentration of DMSO in the reaction mixture was restricted to <2%. The fluorescent conjugate was purified by repeated rounds of centrifugal filtration on a 10 kDa MWCO filtration unit until the flow-though no longer exhibited dye-specific absorption. The ratio of dye:IgG was calculated using the molar extinction coefficient of the dye (ε₆₅₀=239,000M⁻¹cm⁻¹, manufacturer's data) and IgG (ε₂₈₀=203,000M⁻¹cm⁻¹). The final conjugate (dye: IgG, 4:1) was stored in PBS at 4° C. prior to use.

p300 assay: In a final volume of 14 μl, 25 μM substrate peptide was incubated with 40 ng/ml recombinant purified p300 catalytic domain (Millipore) in the presence or absence of 100 μM acetyl-CoA (Sigma-Alrich) and different concentrations of anacardic acid in 50 mM Tris-HCl buffer (pH 8.0) containing 0.1% (w/v) BSA (reaction buffer) for 2 hr at 30° C. An aliquot of this reaction mixture was transferred to a 10 μl solution of 50 nM quantum dots and 300 nM Alexa Fluor 647-labelled anti-AcK antibody to achieve a peptide to Qdot ratio of 40:1 and the mixture allowed to incubate for 30 min at room temperature. Fluorescence intensity data were collected with 1 nM intervals on a SpectraMax M5 microplate reader (Molecular Devices) using a 400 nm excitation source.

To prove the applicability of the present invention to the measurement of HAT activity, a system was designed to detect the acetyltransferase activity of the catalytic domain of the enzyme p300. p300 is a well-known HAT enzyme which acetylates lysine residues contained within the N-terminal region of histone proteins. A synthetic peptide substrate for p300 containing an appending hexahistidine motif was exposed to p300 enzyme in the presence of acetyl-CoA to allow enzymatic acetylation of the peptide. An aliquot of the enzyme reaction mixture was transferred to a quantum dot solution to allow the acetylated substrate peptide to self-assemble on the quantum dot surface. This acetylation event was detected by means of an anti-acetyl lysine antibody labelled with a fluorescent dye, which binds selectively to the acetylated lysine residues of the quantum dot-bound peptide. The resultant decreased distance between the quantum dot and the antibody-conjugated fluorescent dyes is manifested in a diminished quantum dot photoluminescence emission and enhanced dye-emission due to non-radiative energy transfer from the quantum dot to the dye. This is indicated in the fluorescence spectra as a concomitant decrease in emission at 605 nm and enhanced emission at 670 nm from the Qdot and dye molecules respectively—see FIG. 8. Treatment of the p300 enzyme with serial dilutions of a known small-molecule inhibitor, anacardic acid (J. Biol. Chem. 278, 19134-19140 (2003)), revealed dose-dependent decrease in dye-specific emission at 670 nm, suggesting that the assay can be used to screen the effect of other potential inhibitor compounds in drug-discovery applications—see FIG. 9.

1. An assay, comprising:
a first moiety comprising a transferase substrate; and
a second moiety capable of binding to the transferase substrate after it has been acted on by the transferase,
wherein one of the first and second moieties comprises a fluorophore and the other of the first and second moieties causes a change in fluorescence of the fluorophore, such that, when the second moiety binds the transferase substrate after it has been acted on by the transferase, a change in fluorescence can be detected.

2. The assay as claimed in claim 1, wherein the fluorophore is a photoluminescent semiconductor nanocrystal.

3. The assay as claimed in claim 1, wherein the moiety which causes a change in fluorescence of the fluorophore is a proximal acceptor molecule.

4. The assay as claimed in claim 3, wherein the acceptor molecule is an organic dye.

5. The assay as claimed in claim 1, wherein the second moiety binds to the group or groups that the transferase causes to be attached to the transferase substrate.

6. The assay as claimed in claim 5, wherein the second moiety is a monoclonal antibody.

7. The assay as claimed in claim 1, wherein the first moiety comprises said fluorophore and said transferase substrate is attached or otherwise immobilised thereon/thereto, and the second moiety causes a change in fluorescence of the fluorophore.

8. The assay as claimed in claim 1, wherein the transferase is a kinase.

9. The assay as claimed in claim 8, wherein the second moiety is a monoclonal antibody that binds specifically to a phosphate group.

10. The assay as claimed in claim 1, wherein the transferase is an acetyl transferase

11. The assay as claimed in claim 10, wherein the second moiety is a monoclonal antibody that binds specifically to an acetyl group.

12. A method for screening for an agent that modulates the activity of a transferase, comprising:
contacting the transferase, in the presence of an agent to be screened, with a first moiety comprising a transferase substrate; and a second moiety capable of binding to the transferase substrate after it has been acted on by the transferase,
wherein one of the first and second moieties comprises a fluorophore and the other of the first and second moieties causes a change in fluorescence of the fluorophore, such that, when the second moiety binds the transferase substrate after it has been acted on by the transferase, a change in fluorescence can be detected, and wherein the agent is a modulator of the activity of the transferase if the change in fluorescence is altered in the presence of the agent compared to the change in fluorescence when the agent is absent.

13. The method as claimed in claim 12, wherein the fluorophore is a photoluminescent semiconductor nanocrystal.

14. The method as claimed in claim 12, wherein the moiety which causes a change in fluorescence of the fluorophore is a proximal acceptor molecule.

15. The method as claimed in claim 14, wherein the acceptor molecule is an organic dye.

16. The method as claimed in claim 12, wherein the second moiety binds to the group or groups that the transferase causes to be attached to the transferase substrate.

17. The method as claimed in claim 12, wherein the second moiety is a monoclonal antibody.

18. The method as claimed in claim 12, wherein the first moiety comprises said fluorophore and said transferase substrate is attached or otherwise immobilised thereon/thereto, and the second moiety causes a change in fluorescence of the fluorophore.

19. The method as claimed in claim 12, wherein the transferase is a kinase.

20. The method as claimed in claim 19, wherein the second moiety is a monoclonal antibody that binds specifically to a phosphate group.

21. The method as claimed in claim 12, wherein the transferase is an acetyl transferase

22. The method as claimed in claim 21, wherein the second moiety is a monoclonal antibody that binds specifically to an acetyl group.
